(19) United States
(12) Patent Application Publication
(10) Pub. No.: US 2005/0030551 A1
(43) Pub. Date: Feb. 10, 2005

(54) Analysis and monitoring of stresses in embedded lines and vias integrated on substrates

(76) Inventors: Ares J. Rosakis, Altadena, CA (US); Tae-Soon Park, Cambridge, MA (US); Subra Suresh, Wellesley, MA (US)

Correspondence Address: FISH & RICHARDSON, PC, 12390 EL CAMINO REAL, SAN DIEGO, CA, 92130-2081, US

(21) Appl. No.: 10/766,512

(22) Filed: Jan. 27, 2004

Related U.S. Application Data
(60) Provisional application No. 60/443,211, filed on Jan. 27, 2003.

(51) Int. Cl. G01B 9/02

(52) U.S. Cl. 356/521; 356/35.5

(57) ABSTRACT

Techniques and systems for applying analytical computations of stresses to layers with embedded line features to obtain stress information, to design microstructures, and to design and control fabrication processes.

This application claims the benefit of U.S. Provisional Application No. 60/443,211 filed on Jan. 27, 2003, the entire disclosure of which is incorporated herein by reference as part of this application.

This application relates to stresses in device features fabricated on substrates including integrated structures having multiple layers.

Substrates formed of suitable solid-state materials may be used as platforms to support various structures, such as multilevel, thin film microstructures deposited on to the substrates. Integrated electronic circuits, integrated optical devices and opto-electronic circuits, micro-electro-mechanical systems (MEMS), and flat panel display systems (e.g., LCD and plasma displays) are examples of such structures integrated on various types of substrates. Substrates may be made of a semiconductor material (e.g., silicon wafers), silicon on insulator wafer (SOI), a glass material, and others. Different material layers or different structures may be formed on the same substrate in these structures and are in contact with one another to form various interfaces. Some devices may also use complex multilayer or continuously graded geometries and may form various three dimensional structures.

Hence, the interfacing of different materials and different structures may cause a complex stress state in each device feature due to differences in the material properties, e.g., either or both of mechanical and thermal properties. A complex stress state may also be present in the structure at interconnections subject to various fabrication conditions and environmental factors (e.g., variations or fluctuations in temperature). In fabrication of an integrated circuit, for example, the stress state of the interconnect conducting lines may be affected by processing steps such as film deposition, thermal cycling, chemical-mechanical polishing (CMP) or other layer thinning processes, and by passivation capping or encapsulation. Stresses caused by these and other factors may adversely affect the integrity or effectiveness of subsequent processing steps, or the performance and reliability of the devices. Such stresses may even cause failure of the component or device under action of such stresses.

For at least these reasons, it may be desirable to analyze, measure and monitor stresses, changes in stresses, and stress accumulation history and stress budget of a substrate and of features fabricated on the substrate. For example, stresses on various features formed on the substrate may be analyzed to improve the design of the device structure, selection of materials, fabrication processes, and other aspects of the devices so that the yield, device performance, and device reliability can be enhanced. The stress measurements may be used to assess or evaluate the reliability of materials against failures from such phenomena as stress migration, stress-induced voiding in features such as metal lines and vias, dielectric cracking, delamination, hillock formation, and electromigration. The stress measurements may also be used to facilitate quality control of the mechanical integrity and electromechanical functioning of circuit chip dies during large scale production in wafer fabrication facilities. In addition, the stress measurements may be used to improve the designs of various fabrication processes and techniques, such as thermal treatments (e.g., temperature excursions during passivation, annealing, or curing) and chemical and mechanical treatments (e.g., polishing or thinning) to reduce residual stresses in the completed components or devices.

### SUMMARY

One widely-used structure that is commonly found in various substrate-based devices is line features embedded in different materials that are supported by a substrate. For example, conductive lines are often embedded in an insulating material such as an oxide layer, a nitride layer, or other low-k dielectric layer formed over the substrate. Copper lines are often fabricated by using a Damascene process where trenches with the same dimensions as the geometry of desired copper interconnect lines are etched in an oxide layer grown on a silicon substrate and then copper is deposited in the trenches to form the embedded copper interconnect lines. The extra copper above trenches is then removed by, e.g., polishing. In some implementations, an additional capping layer of the same material as the oxide layer or a different dielectric material may be formed on top of the lines. Two or more layers with such embedded line features may be formed over the same substrate. In addition, vias perpendicular to the substrate may be used to provide vertical interconnections for line features embedded in different layers.

This application includes systems and techniques for analysis and monitoring of stresses in integrated structures, with embedded line features and vias, using analytical computations. The integrated structures may include various integrated circuits (e.g., circuits with doped and strained semiconductors regions), integrated opto-electronic devices, and MEMS devices, and others. Based on a thermoelastic composite analysis, analytical expressions for changes in stresses are provided as functions of the properties of materials, the dimensions of the device features such as lines, vias, and the surrounding dielectric films, and changes in the local surface curvature and the local temperature. The surrounding dielectric films may include capping layers formed on top of the embedded line features. Such analytical expressions allow for direct computations of changes in local feature stresses without complex and computation-intensive numerical computations. Such analytical computations may be used in designing various types of integrated structures in such a way as to maintain stresses below desired levels in fabrication and in operations of the devices. Hence, the layer structure and feature architecture, the materials in the structure, and the fabrication processes may be properly designed or selected during the design process to ensure desired stress behaviors during the fabrication and in normal use or operation of the devices.

During fabrication of one or more wafers, changes in stresses on a wafer may be caused by, for example, thermal cycling or a transition from one processing step to another during fabrication. Therefore, a system may be designed based on the analytical computations to provide in-situ and real time monitoring of stresses in wafers because the analytical expressions described here allow for fast processing of measurements of the wafer curvature and temperature. This in-situ monitoring of build-up of stresses during fabrication may be used to improve the overall yield of the fabrication process by, for example, allowing for adjusting the processing conditions through a feedback control mechanism and by screening defective wafers prior to the completion of the entire fabrication processes.

This application describes a method for designing a layered structure on a substrate as one example of various methods. In this example, a layered structure is provided to include at least one layer over a substrate and parallel line features embedded in the layer. Analytical expressions are used to compute stresses in a line feature from curvature information of the substrate in an area of the line feature, geometry information of the line feature and the layer, and material information of the line feature, the layer and the substrate. The computed stresses are then used to determine whether a stress-induced failure condition is met. A parameter of the layered structure is adjusted if the stress-induced failure condition is met and the analytical expressions are used again to compute stresses in the line feature based on the adjusted parameter. The parameter is continued to be adjusted until the stress-induced failure condition is not met.

As another example, this application also describes a method for fabricating a layered structure on a substrate. A substrate is first processed to form at least one layer on the substrate and parallel line features embedded in the layer. The local curvature information in an area of a line feature is then obtained. The local temperature information in the area of the line feature is also obtained. Next, analytical expressions are used to compute local stresses in the line feature from the local curvature information and the local temperature information of the line feature, geometry information of the line feature and the layer, and material information of the line feature, the layer and the substrate.

A system according to one exemplary implementation in this application includes a substrate holder to hold a substrate fabricated with a layer and parallel line features embedded in the layer, a sensing module to interact with the substrate to obtain information about a temperature and curvatures of a line feature on the substrate, and a processing module programmed with analytical expressions to compute local stresses in the line features. The analytical expressions are functions of curvature information of an area having the line feature, local temperature information, geometry information of the line feature and the layer, and material information of the line feature, the layer and the substrate.

Applications of the monitoring and analysis techniques based on analytical expressions may be applied to wafers and substrates with multiple integrated layers in, e.g., designing and fabricating such multiple layers. In one implementation, a layered structure is provided to include a plurality of layers stacked over one another and each having embedded line features. Information on a surface of the layered structure is optically obtained. The optically obtained information is processed to extract curvature information of the surface. Analytical expressions are then applied to compute local stresses in a line feature based on extracted curvature information and a local temperature at a location of the line feature.

In some fabrication processes, the processing results based on the analytical expressions for stresses may be used to monitor the wafer under processing and the processing conditions may be controlled or adjusted based on the processing results.

These and other implementations, examples, and their variations, and advantages are described in greater detail in the drawings, the detailed description, and the claims.

### BRIEF DESCRIPTION OF THE DRAWINGS

FIG. 1A shows one thin layer with embedded, parallel tall line features formed on a thick substrate, where the line features may be capped by a capping layer.

FIG. 1B shows a multi-layer structure having two or more layers with embedded, parallel thin line features over a thick substrate.

FIG. 2 shows one exemplary structure based on the structural geometries in FIGS. 1A and 1B that includes periodic cylindrical vias that are interconnected between two aligned and parallel line features at two adjacent layers.

FIG. 3 shows computed amplification factors as a function of the volume fraction of the vias for two exemplary encapsulating or passivating materials, where a is a ration between the critical level of hydrostatic stress sufficient to nucleate a void over the uniaxial yield (flow) stress of the material in the line.

FIG. 4 illustrates cavitation or stress-induced growth of a void in one of the line features in FIGS. 1A, 1B, and 2 when the stresses in that line feature meet an associated failure criterion.

FIGS. 5, 6, 7 illustrate examples for establishing critical thresholds as a function of line geometry for a single level structure of encapsulated or embedded periodic lines.

FIGS. 8, 9, 10 and 11 show examples for estimating critical threshold values for vias as functions of line and via geometry parameters for configurations specified in the captions.

FIG. 12 shows one exemplary stress monitoring system using analytical expressions described here as part of the system for processing measured data.

FIG. 13 shows an exemplary stress measurement system using an optical detection module and the analytical expressions described as part of its processing module.

FIG. 14 shows an exemplary coherent gradient sensing (“CGS”) system as one implementation of an optical shearing system for the optical detection module in FIG. 13.

FIG. 15 illustrates a two-arm CGS system having two separate sets of double gratings in two different directions to simultaneously produce the interference pattern in two different, orthogonal spatial shearing directions.

FIG. 16 illustrates an exemplary process for applying the above method using the optical method to compute the stresses in a multi-layered structure deposited on a wafer.

### DETAILED DESCRIPTION

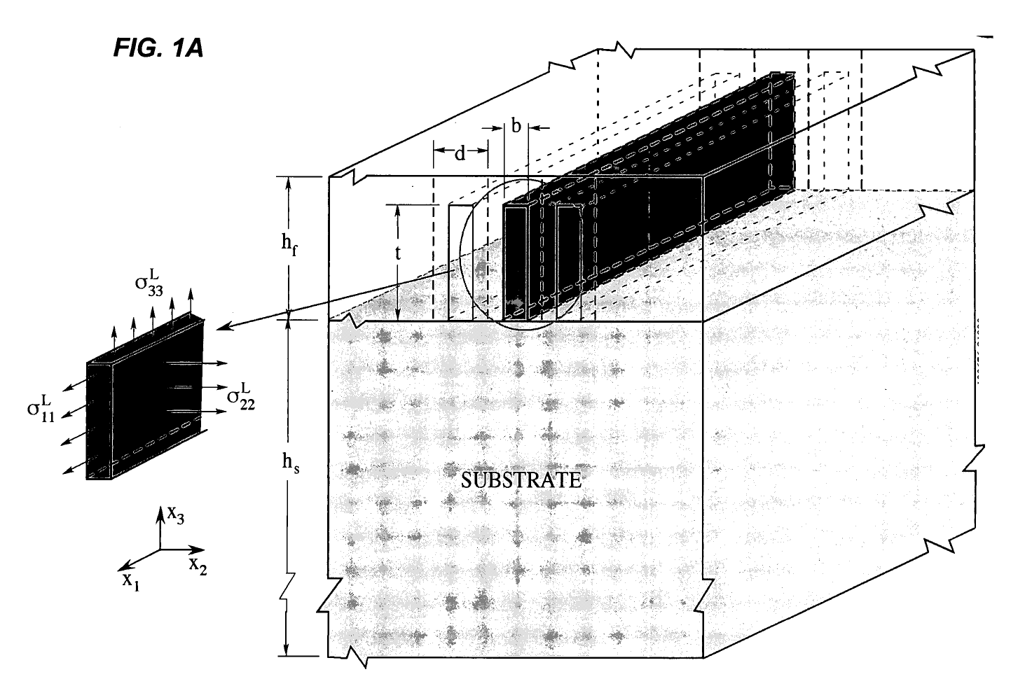

FIGS. 1A and 1B show geometries representative of exemplary integrated structures for the analytical computations and expressions of stresses described based on a thermoelastic composite analysis. FIG. 1A shows one layer with embedded, parallel tall line features formed on a thick substrate. FIG. 1B shows a multi-layer structure having two or more layers with embedded, parallel line features over the substrate. In general, such a multi-layer structure has n layers where a 2-layer example for n=2 is illustrated in FIG. 1B. A Cartesian coordinate system (x1,x2,x3) is shown in the insert. The directions marked as x1 and x2 represent two orthogonal directions parallel to the substrate where the direction x1 is along the longitudinal direction of the line features in the layer and the direction x2 is perpendicular to the line features. The direction marked as x3 represents the direction normal to the plane of the substrate.

In each layer for a multi-layer structure, the embedded line features are substantially parallel to one another to form an array along the direction x2 and are substantially evenly spaced with a spatial period or pitch of d. The thickness of each layer is denoted by h_{f}. The embedded line features in each layer may be capped by a capping layer formed of either the same material as the material embedding the line features or a different material. In presence of the capping layer, the layer thickness h_{f} is greater than the height or thickness, t, of each line feature and the thickness of the capping layer is (h_{f}−t).

As an example, the present analytical thermoelastic analysis is based on the assumption that the total height (nh_{f}) of the multiple layers and the height (t) of each embedded line feature are much less than the thickness (hₛ) of the underlying substrate and that the transverse dimensions L and W of the substrate are much greater than its thickness hₛ, e.g., by a factor of 10 or greater. In addition, the line features are “tall” where the line height (t) is greater than the line width (b), e.g., t≧1.1b. The accuracy of the analytical thermoelastic analysis depends on these assumptions and generally increases as these factors increase.

Under these conditions, the stresses in each embedded line in FIGS. 1A and 1B can be expressed as explicit analytical functions of changes in components of curvature, a change in temperature, the feature geometry (e.g., line, dielectric layer and via dimensions, height of each layer, the substrate thickness, etc.) and material properties of line features and surrounding material(s), e.g., Young's moduli, Poisson's Ratios and thermal expansion coefficients of the line features, dielectric layers, and the vias. A change in curvature and temperature connotes net differences between the end and the beginning states of a wafer undergoing a process such as a deposition, or a thermal excursion during fabrication. For example, the stress tensor components σ₃₃¹, σ₂₂¹, and σ₁₁¹ in an embedded line feature in a single layer structure (n=1) without a capping layer (h_{f}=t in this case) can be expressed as follows:

$$\begin{matrix}\begin{matrix}{σ}_{33}^{l} = \frac{1}{[ {f}_{l} {E}_{l} ( 1 - {v}_{o} ) + {f}_{o} {E}_{o} ( 1 - {v}_{l} ) ]} \\ \{ \frac{{f}_{o} {E}_{o} {E}_{l} ( {v}_{l} - {v}_{o} )}{[ {f}_{l} {E}_{l} ( 1 + {v}_{o} ) + {f}_{o} {E}_{o} ( 1 + {v}_{l} ) ]} \frac{{E}_{s} {h}_{s}^{2}}{6 {h}_{f} ( 1 - {v}_{s}^{2} )} \\ ( {K}_{11} + {v}_{s} {K}_{22} ) + {f}_{o} ( {E}_{o} {v}_{l} - {E}_{l} {v}_{o} ) \frac{{E}_{s} {h}_{s}^{2}}{6 {h}_{f} ( 1 - {v}_{s}^{2} )} \\ ( {v}_{s} {K}_{11} + {K}_{22} ) + {f}_{o} {E}_{l} {E}_{o} ( {α}_{o} - {α}_{l} ) Δ T \} ,\end{matrix} & ( 1 ) \\ {σ}_{22}^{l} = \frac{{E}_{s} {h}_{s}^{2}}{6 {h}_{f} ( 1 - {v}_{s}^{2} )} ( {v}_{s} {K}_{11} + {K}_{22} ) , & ( 2 ) \\ \begin{matrix}{σ}_{11}^{l} = \frac{1}{[ {f}_{l} {E}_{l} ( 1 - {v}_{o} ) + {f}_{o} {E}_{o} ( 1 - {v}_{l} ) ]} \\ \{ \frac{{f}_{l} {E}_{l}^{2} ( 1 - {v}_{o}^{2} ) + {f}_{o} {E}_{o} {E}_{l} ( 1 - {v}_{o} {v}_{l} )}{[ {f}_{l} {E}_{l} ( 1 + {v}_{o} ) + {f}_{o} {E}_{o} ( 1 + {v}_{l} ) ]} \frac{{E}_{s} {h}_{s}^{2}}{6 {h}_{f} ( 1 - {v}_{s}^{2} )} \\ ( {K}_{11} + {v}_{s} {K}_{22} ) + {f}_{o} ( {E}_{o} {v}_{l} - {E}_{l} {v}_{o} ) \frac{{E}_{s} {h}_{s}^{2}}{6 {h}_{f} ( 1 - {v}_{s}^{2} )} \\ ( {v}_{s}^{l} {K}_{11} + {K}_{22} ) + {f}_{o} {E}_{l} {E}_{o} ( {α}_{o} - {α}_{l} ) Δ T \} .\end{matrix} & ( 3 )\end{matrix}$$

where Eₛ are νₛ are Young's modulus and Poisson's ratio of the substrate, respectively, K₁₁ and K₂₂ are changes in curvature tensor components of the total local curvature of the structure relative to curvature tensor component values at a reference initial state such as a stress-free state (i.e., changes in curvature components caused by a change in temperature), the parameter fₗ is defined by (bt)/(dt)=b/d, i.e., the volume fraction of the lines within their hosting layer of height (t), the parameter fₒ is defined as (1−fₗ) to represent the volume fraction of the material between the lines of height (t), and ΔT is a change in the temperature from a reference temperature such as that of a stress free state. Subscripts “o,” “l,” and “s” represent the encapsulating material (e.g., a low-k dielectric material), embedded line features, and the supporting substrate, respectively. Some of these computation notations are described in Wikstrom, Gudmundson, and Suresh, in “Thermoelastic Analysis of Periodic Thin Lines Deposited on A Substrate,” Journal of the Mechanics and Physics of Solids, vol. 47, pp. 1113-1130 (May, 1999), and U.S. Pat. No. 6,600,565 to Suresh and Rosakis.

The above explicit analytical expressions in Equations (1)-(3) may be slightly modified to represent changes in stress tensor components for a single layer structure that is further capped on top by a capping layer with a thickness of (h_{f}−t). This capping layer may be formed of the same material as the dielectric material that embeds the line features. Alternatively, the capping layer may be formed of a different material. In this modification of the Equations (1)-(3), the parameters h_{f}, K₁₁ and K₂₂ are replaced by t, [K₁₁−K₁₁(cap)] and [K₂₂−K₂₂(cap)], respectively, where K₁₁(cap) and K₂₂(cap) are curvature component contributions respectively along directions x1 and x2 within the layer to the total curvature made by the capping layer. In the modified expressions to include the capping layer, K₁₁ and K₂₂ are changes in the total curvature components of the entire layered structure. Therefore, the differences [K₁₁−K₁₁(cap)] and [K₂₂−K₂₂(cap)] correspond to the curvature contributions of the layer of thickness t hosting the periodic line features. Other parameters in the equations remain unchanged. For example, the parameter fₗ is still the volume fraction of the lines within the hosting layer of thickness t and the parameter f₀ still represents the volume fraction of the material between the line features.

When a single layer structure with an isotropic capping layer is subject to a change in temperature, the tensor components of the capping layer can be specifically expressed as:

$${K}_{11} ( cap ) = {K}_{22} ( cap ) = \frac{6 E ( cap ) ( 1 - {v}_{s} )}{{E}_{s} [ 1 - v ( cap ) ]} \frac{{h}_{f} - t}{{h}_{s}^{2}} [ {α}_{s} - α ( cap ) ] Δ T ,$$

where E(cap), ν(cap), and α(cap) are the Young's modulus, the Poisson's ratio, and the thermal expansion coefficient of the capping layer, respectively. Since the curvature contributions of the capping layer are proportional to its thickness, (h_{f}−t), the modified equations are reduced to the original Equations (1)-(3) when t=h_{f} and both of K₁₁(cap) and K₂₂(cap) are zero. Analytical expressions for a single layer structure with embedded line features and an anisotropic capping layer can also be derived based on the above modifications to Equations (1)-(3).

The above analytical expressions of the stress tensor components for a single layer with embedded line features with and without the capping layer may be extended to a multilayer structure with multiple layers stacked over one another above the substrate. The above expressions may be simply modified by replacing h_{f} with nt, K₁₁ with [K₁₁−K₁₁(cap)], and K₂₂ with [K₂₂—K₂₂(cap)], respectively. The parameter n is the number of layers. For example, changes in stress tensor components in the line feature in each layer of a n-layer structure are written as follows:

$$\begin{matrix}{σ}_{11}^{l} = \frac{1}{[ {f}_{l} {E}_{l} ( 1 - {v}_{o} ) + {f}_{o} {E}_{o} ( 1 - {v}_{l} ) ]} \times \\ \{ \frac{{f}_{l} {E}_{l}^{2} ( 1 - {v}_{o}^{2} ) + {f}_{o} {E}_{o} {E}_{l} ( 1 - {v}_{o} {v}_{l} )}{[ {f}_{l} {E}_{l} ( 1 + {v}_{o} ) + {f}_{o} {E}_{o} ( 1 + {v}_{l} ) ]} \frac{{E}_{s} {h}_{s}^{2}}{6 nt ( 1 - {v}_{s}^{2} )} \\ \{ ( {K}_{11} - {K}_{11} ( cap ) ] + {v}_{s} [ {K}_{22} - {K}_{22} ( cap ) ] \} + \\ {f}_{o} ( {E}_{o} {v}_{l} - {E}_{l} {v}_{o} ) \frac{{E}_{s} {h}_{s}^{2}}{6 nt ( 1 - {v}_{s}^{2} )} \\ \{ {v}_{s} ( {K}_{11} - {K}_{11} ( cap ) ] + [ {K}_{22} - {K}_{22} ( cap ) ] \} + \\ {f}_{o} {E}_{l} {E}_{o} ( {α}_{o} - {α}_{l} ) Δ T \} .\end{matrix}$$

$${σ}_{22}^{l} = \frac{{E}_{s} {h}_{s}^{2}}{6 nt ( 1 - {v}_{s}^{2} )} \{ {v}_{s} ( {K}_{11} - {K}_{11} ( cap ) ] + [ {K}_{22} - {K}_{22} ( cap ) ] \} , \\ \begin{matrix}{σ}_{33}^{l} = \frac{1}{[ {f}_{l} {E}_{l} ( 1 - {v}_{o} ) + {f}_{o} {E}_{o} ( 1 - {v}_{l} ) ]} \times \\ \{ \frac{{f}_{o} {E}_{o} {E}_{l} ( {v}_{l} - {v}_{o} )}{[ {f}_{l} {E}_{l} ( 1 + {v}_{o} ) + {f}_{o} {E}_{o} ( 1 + {v}_{l} ) ]} \frac{{E}_{s} {h}_{s}^{2}}{6 nt ( 1 - {v}_{s}^{2} )} \\ \{ ( {K}_{11} - {K}_{11} ( cap ) ] + {v}_{s} [ {K}_{22} - {K}_{22} ( cap ) ] \} + \\ {f}_{o} ( {E}_{o} {v}_{l} - {E}_{l} {v}_{o} ) \frac{{E}_{s} {h}_{s}^{2}}{6 nt ( 1 - {v}_{s}^{2} )} \\ \{ {v}_{s} ( {K}_{11} - {K}_{11} ( cap ) ] + [ {K}_{22} - {K}_{22} ( cap ) ] \} + \\ {f}_{o} {E}_{l} {E}_{o} ( {α}_{o} - {α}_{l} ) Δ T \} ,\end{matrix}$$

where the curvature components of the capping layers can be expressed as follows for a n layer structure with an isotropic capping layer in each layer:

$${K}_{11} ( cap ) = {K}_{22} ( cap ) = \frac{6 E ( cap ) ( 1 - {v}_{s} )}{{E}_{s} [ 1 - v ( cap ) ]} \frac{n ( {h}_{f} - t )}{{h}_{s}^{2}} [ {α}_{s} - α ( cap ) ] Δ T .$$

In the case where there is no capping layer (h_{f}=t and K₁₁(cap) and K₂₂(cap) are zero, the stress tensor components can be reduced to the following equations:

$$\begin{matrix}{σ}_{11}^{l} = \frac{1}{[ {f}_{l} {E}_{l} ( 1 - {v}_{o} ) + {f}_{o} {E}_{o} ( 1 - {v}_{l} ) ]} \\ \{ \frac{{f}_{l} {E}_{l}^{2} ( 1 - {v}_{o}^{2} ) + {f}_{o} {E}_{o} {E}_{l} ( 1 - {v}_{o} {v}_{l} )}{[ {f}_{l} {E}_{l} ( 1 + {v}_{o} ) + {f}_{o} {E}_{o} ( 1 + {v}_{l} ) ]} \frac{{E}_{s} {h}_{s}^{2}}{6 {nh}_{f} ( 1 - {v}_{s}^{2} )} \\ ( {K}_{11} + {v}_{s} {K}_{22} ) + {f}_{o} ( {E}_{o} {v}_{l} - {E}_{l} {v}_{o} ) \frac{{E}_{s} {h}_{s}^{2}}{6 {nh}_{f} ( 1 - {v}_{s}^{2} )} \\ ( {v}_{s} {K}_{11} + {K}_{22} ) + {f}_{o} {E}_{l} {E}_{o} ( {α}_{o} - {α}_{l} ) Δ T \} .\end{matrix}$$

$${σ}_{22}^{l} = \frac{{E}_{s} {h}_{s}^{2}}{6 {nh}_{f} ( 1 - {v}_{s}^{2} )} ( {v}_{s} {K}_{11} + {K}_{22} ) , \\ \begin{matrix}{σ}_{33}^{l} = \frac{1}{[ {f}_{l} {E}_{l} ( 1 - {v}_{o} ) + {f}_{o} {E}_{o} ( 1 - {v}_{l} ) ]} \\ \{ \frac{{f}_{o} {E}_{o} {E}_{l} ( {v}_{l} - {v}_{o} )}{[ {f}_{l} {E}_{l} ( 1 + {v}_{o} ) + {f}_{o} {E}_{o} ( 1 + {v}_{l} ) ]} \frac{{E}_{s} {h}_{s}^{2}}{6 {nh}_{f} ( 1 - {v}_{s}^{2} )} \\ ( {K}_{11} + {v}_{s} {K}_{22} ) + {f}_{o} ( {E}_{o} {v}_{l} - {E}_{l} {v}_{o} ) \frac{{E}_{s} {h}_{s}^{2}}{6 {nh}_{f} ( 1 - {v}_{s}^{2} )} \\ ( {v}_{s} {K}_{11} + {K}_{22} ) + {f}_{o} {E}_{l} {E}_{o} ( {α}_{o} - {α}_{l} ) Δ T \} .\end{matrix}$$

The above explicit analytical expressions for various layer configurations allow for direct computation of changes in stresses of a line feature embedded in either a single layer structure or a multiple layer structure at any location from changes in local curvatures parallel and perpendicular to a line feature and from a change in the local temperature at that location. Therefore, if changes in the curvature and the temperature are known, e.g., by measurements, the associated change in stress at a given line feature or a stress distribution of all line features in that layer may be analytically computed without computation-intensive numerical computations. Accordingly, a stress monitoring system may be constructed by having a surface curvature measuring module for monitoring the curvatures and their changes, a temperature sensing module for sensing temperatures and their changes, and a processing module that is programmed to perform the above computations.

The above changes in the stress components σ₃₃¹ and σ₁₁¹ include two different contributions. One contribution is related to changes in both components of the local curvature and the other is proportional to temperature deviation, ΔT, from a reference state (e.g., an initial, stress-free stress state such as cooling from an anneal or from passivation). The curvature-dependent contribution represents the effect of thermal mismatches, e.g., the thermal mismatch between the embedded line feature and the substrate, and the thermal mismatch between the encapsulating or passivating material and the substrate. This contribution is an external contribution to stresses and can be calculated from curvature information. The second part represents the effect of thermal mismatch between two phases in the film structure (i.e. between metal lines and their encapsulating or passivating low-k dielectric material surrounding the metal lines). This second contribution is self-equilibrated and does not produce a change in curvature. Hence, this second contribution represents an intrinsic thermal contribution to stresses. The stress tensor component σ₂₂¹, which is the stress component perpendicular to the line feature within the layer, has only the external contribution and thus depends on the local curvature only and does not have a dependence on the local temperature.

Therefore, in this exemplary implementation of the thermoelastic composite analysis, both the changes in curvature and temperature at a location are used in the analytical expressions to determine stresses of line features in structures shown in FIGS. 1A and 1B. Under certain circumstances, however, the above analytical expressions may be further simplified.

For example, if the embedded periodic line features in a n-layer structure are uniformly distributed over the entire substrate and the temperature is also uniform throughout the entire structure, the stress tensor components may be expressed as functions of the change in temperature, ΔT, only. Such analytical expressions with dependence on temperature change only may be achieved by expressing the spatially-constant curvature change of the line structures as a function of ΔT in Equations (1)-(3) or the modified equivalent equations for structures with capping layers or multiple layers as long as the relationship between the change in temperature and the surface curvatures remains a linear function before reaching the yield point. Accordingly, under this special circumstance, the change in temperature is sufficient for evaluating the stresses and thus circumvents the need to measure local surface curvatures. For example, the stress tensor component σ₃₃¹ on a line feature, e.g., at any level of a multilayer structure, can be expressed solely as a function of the change in temperature as follows:

$$\begin{matrix}{σ}_{33}^{l} = \frac{\{ {f}_{1} {E}_{1} ( {α}_{s} - {α}_{1} ) + {f}_{0} {E}_{0} ( {α}_{s} - {α}_{0} ) \} ( 1 - {v}_{s} )}{\{ {f}_{1} ( 1 - {v}_{0} ) {E}_{1} + {f}_{0} ( 1 - {v}_{1} ) {E}_{0} 〈 ( 1 - {f}_{1} {v}_{1} - {f}_{0} {v}_{0} )} \\ \{ \frac{{f}_{0} ( {v}_{1} - {v}_{0} ) {E}_{1} {E}_{0}}{[ {f}_{1} {E}_{1} ( 1 + {v}_{0} ) + {f}_{0} {E}_{0} ( 1 + {v}_{1} ) ] ( 1 - {v}_{s}^{2} )} \times \\ ( 1 + \frac{{v}_{s} {E}_{1} {E}_{0} \{ {α}_{s} - ( {f}_{1} {α}_{1} + {f}_{0} {α}_{0} ) \}}{( {f}_{1} {E}_{0} + {f}_{0} {E}_{1} ) [ {f}_{1} {E}_{1} ( {α}_{s} - {α}_{1} ) + {f}_{0} {E}_{0} ( {α}_{s} - {α}_{0} ) ]} ) + \\ \frac{{f}_{0} ( {v}_{1} {E}_{1} - {v}_{0} {E}_{1} )}{( 1 - {v}_{s}^{2} )} \\ ( {v}_{s} + \frac{{E}_{0} {E}_{1} \{ {α}_{s} - ( {f}_{1} {α}_{1} + {f}_{0} {α}_{0} ) \}}{( {f}_{1} {E}_{0} + {f}_{0} {E}_{1} ) [ {f}_{1} {E}_{1} ( {α}_{s} - {α}_{1} ) + {f}_{0} {E}_{0} ( {α}_{s} - {α}_{0} ) ]} ) + \\ \frac{{f}_{0} {E}_{0} {E}_{1} ( {α}_{0} - {α}_{1} )}{[ {f}_{1} {E}_{1} ( {α}_{s} - {α}_{1} ) + {f}_{0} {E}_{0} ( {α}_{s} - {α}_{0} ) ]} \frac{1 - {f}_{1} {v}_{1} - {f}_{0} {v}_{0}}{( 1 - {v}_{s} )} \} Δ T\end{matrix} \qquad ( 4 )$$

Similarly, stress components σ₂₂¹ and σ₁₁¹ may be expressed as functions of ΔT without dependence on the curvature. Therefore, the stresses of such a structure, including a multi-layer structure, may be monitored and measured by using a temperature sensing module.

Conversely, in the above special circumstance, each local stress tensor component may also be expressed as a function of one of the two local curvatures along x1 and x2 directions without explicit dependence on the change in temperature:

$$\begin{matrix}{σ}_{33}^{l} = \frac{1}{[ {f}_{l} {E}_{l} ( 1 - {v}_{o} ) + {f}_{o} {E}_{o} ( 1 - {v}_{l} ) ]} \\ \{ \frac{{f}_{o} {E}_{o} {E}_{l} ( {v}_{l} - {v}_{o} )}{[ {f}_{l} {E}_{l} ( 1 + {v}_{o} ) + {f}_{o} {E}_{o} ( 1 + {v}_{l} ) ]} \frac{1 + {Lv}_{s}}{( 1 - {v}_{s}^{2} )} + \\ \frac{{f}_{o} ( {E}_{o} {v}_{l} - {E}_{l} {v}_{o} )}{( 1 - {v}_{s}^{2} )} ( {v}_{s} + L ) + {f}_{o} {E}_{l} {E}_{o} ( {α}_{o} - {α}_{l} ) M \} \\ \frac{{E}_{s} {h}_{s}^{2}}{6 nt} [ {K}_{11} - {K}_{11} ( cap ) ]\end{matrix} \qquad ( 5 )$$

where L is the ratio of curvature components defined by:
[K₂₂−K₂₂ (cap)]/[K₁₁−K₁₁(cap)],
and M is defined through the following equation:

$$Δ T = \frac{{E}_{s} {h}_{s}^{2}}{6 nt} M [ {K}_{11} - {K}_{11} ( cap ) ] ,$$

and M can be explicitly expressed as following:

$$M = \frac{1 - {f}_{l} {v}_{l} - {f}_{o} {v}_{o}}{[ {f}_{l} {E}_{l} ( {α}_{s} - {α}_{l} ) + {f}_{o} {E}_{o} ( {α}_{s} - {α}_{o} ) ] ( 1 - {v}_{s} )}$$

A more explicit expression for the parameter L can be written as follows:

$$L = \frac{1}{[ {f}_{l} {E}_{o} + {f}_{o} {E}_{l} ]} \frac{{α}_{s} - ( {f}_{l} {α}_{l} + {f}_{o} {α}_{o} )}{[ {f}_{l} {E}_{l} ( {α}_{s} - {α}_{l} ) + {f}_{o} {E}_{o} ( {α}_{s} - {α}_{o} ) ) ]} .$$

The above analytical expression is derived by using the relation between each of the curvature components and temperature to eliminate ΔT and to express stress in terms of either curvature component. Hence, a single curvature measurement module may be used to monitor and measure the stresses. For the case where there is no capping layer in each of the multiple layers, the above stress equation can be reduced to the following simplified form:

$${σ}_{33}^{l} = \frac{1}{[ {f}_{l} {E}_{l} ( 1 - {v}_{o} ) + {f}_{o} {E}_{o} ( 1 - {v}_{l} ) ]} \{ \frac{{f}_{o} {E}_{o} {E}_{l} ( {v}_{l} - {v}_{o} )}{[ {f}_{l} {E}_{l} ( 1 + {v}_{o} ) + {f}_{o} {E}_{o} ( 1 + {v}_{l} ) ]} \frac{1 + L {v}_{s}}{( 1 - {v}_{s}^{2} )} + \frac{{f}_{o} ( {E}_{o} {v}_{l} - {E}_{l} {v}_{o} )}{( 1 - {v}_{s}^{2} )} ( {v}_{s} + L ) + {f}_{o} {E}_{l} {E}_{o} ( {α}_{o} - {α}_{l} ) M \} \frac{{E}_{s} {h}_{s}^{2}}{6 n t} [ {K}_{11} ]$$

In addition to in-plane layer, horizontal line features in each layer, certain multi-layer structures and devices may have one or more vertical holes or conduits (vias) through one or more layers to interconnect line features of different layers. One example of such vias is a vertical conductive lead typically formed of a metal (e.g., Cu, W, etc.) or a suitable conductive material filling the via. Typically, two ends of a vertical interconnect in the via is connected to two conductive line features at different layers as the inter-layer connection. This addition of one or more via connections can impact the stresses on the connected line features and the via connections. Presence of via connections complicates the stress pattern in such devices. Therefore, it may be desirable to include effects of vias in the stress analysis and to investigate the effect of via dimensions and spatial distribution on the stress state of the structure.

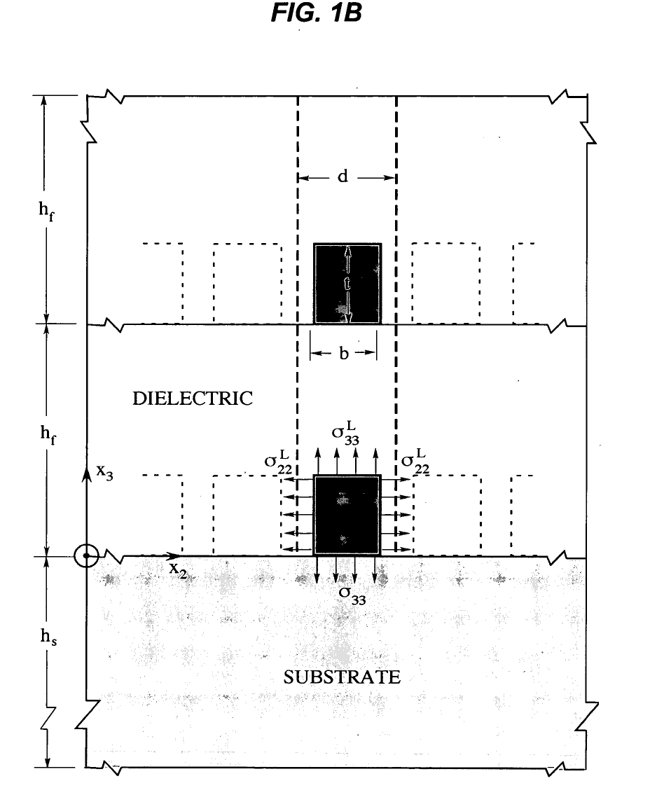

FIG. 2 shows one exemplary structure based on the structural geometries in FIGS. 1A and 1B that includes periodic cylindrical vias with a via diameter of 2R, a pitch of V, and a height of hᵥ that are interconnected between two aligned and parallel line features of an equal line width b at two adjacent layers. For simplicity in this example, the capping layer between the top of the line features in one layer and the bottom of an adjacent top layer is assumed to be made of the same material as the material filled between the line features. Based on this example, the stress along the x3 direction (perpendicular to the substrate) can be expressed in the following analytical form as a function of the local surface curvature and the change in the local temperature:

$${σ}_{33}^{v} = \frac{b V / π R}{[ \frac{{E}_{o}}{{E}_{v}} ( \frac{b V}{π {R}^{2}} - 1 ) + 1 ]} ( {σ}_{33}^{L} + {E}_{0} ( 1 - \frac{π {R}^{2}}{b V} ) ( {α}_{0} - {α}_{v} ) Δ T ) , \qquad ( 6 )$$

where the ratio of πR²/(bV) is denoted as fᵥ to represent the volume fraction of the via:

$${f}_{v} = \frac{π {R}^{2}}{b V} .$$

In Equation (6), the vertical stress σ₃₃^{V} on each via has two components. The first component is proportional to the vertical stress σ₃₃¹ on a connected line feature at the same location which can be derived from Equations (1)-(5) and the respective modifications to include the capping layer and the multiple layers. The second component is dependent on the temperature variation ΔT. Due to these two components, the stress σ₃₃^{V} on each via is “amplified” with respect to the line feature stress σ₃₃^{L}.

In addition, when the capping layer is made of an isotropic material different from the material between the line features, the above Equation (6) may be modified by replacing Eₒ and αₒ with E(cap) and α(cap), respectively. If the capping layer is formed of an anisotropic material, values of these material properties should be the corresponding values along the vertical directions.

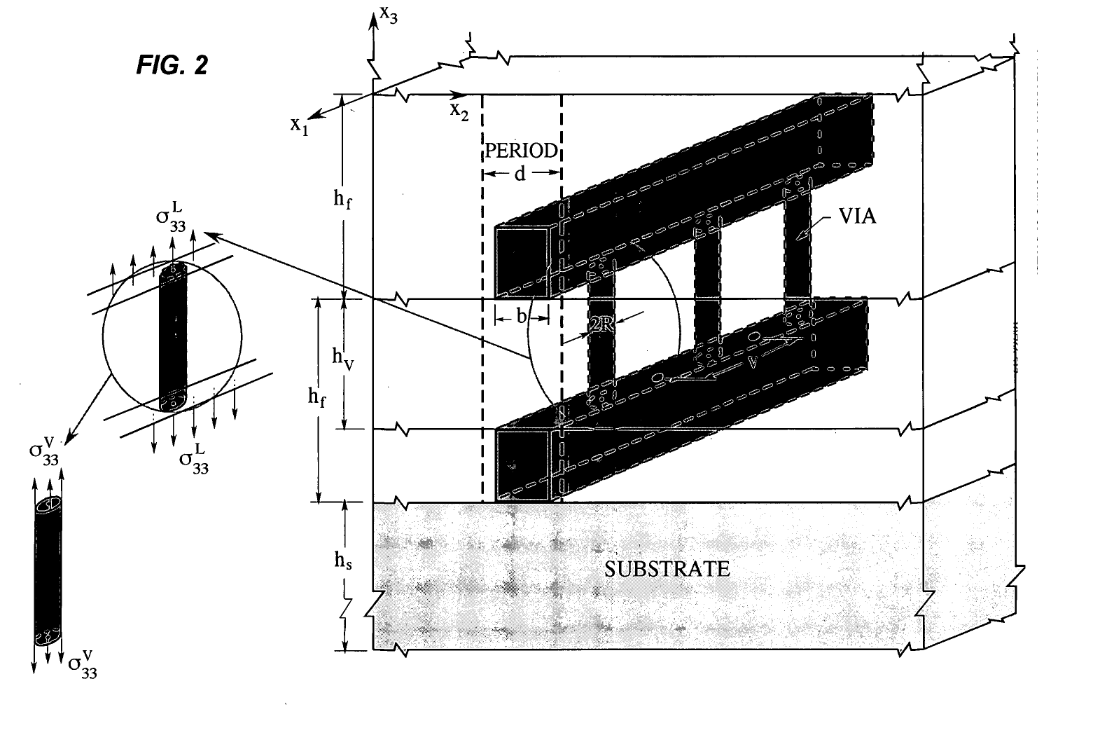

FIG. 3 shows computed amplification factors as a function of the ratio fᵥ for two encapsulating or passivating materials (e.g., commercial materials under trade names of TEOS and SILK) of the same via structure with copper (Cu) and tungsten (W) line features and vias. In this example, E(cap) and Eₒ are identical. The change in temperature for the values in FIG. 3 is 380 degrees Celsius.

In the above description, the embedded line features in a layer are shown to be parallel to and are respectively aligned along the x1 direction with parallel line features of an adjacent layer in FIG. 1B. The application of analytical functions for stresses described here, however, is not limited to this configuration. For example, these analytical functions for stresses may be used for configurations where the line features of one layer are parallel to but are shifted by a common distance along the x2 direction with respect to line features of an adjacent layer. As another example, these analytical functions for stresses may be used for configurations where the line features of one layer are substantially perpendicular to the parallel line features of an adjacent layer.

Integrated structures or devices may be designed to have similar layer configurations as those shown in FIGS. 1A, 1B, and 2. For example, in some devices, the line features may be conductive lines such as metallic lines embedded in a dielectric layer (e.g., an oxide or nitride layer or another suitable insulator or dielectric layer). Hence, the analytical functions for stresses described here may be used to monitor and analyze the stresses during the fabrication and in a completed component or device. In other devices, similar multilayer configurations shown in FIGS. 1A, 1B, and 2 may temporarily exist during certain stages in their fabrication processes and may subsequently be altered into other configurations upon completion of the fabrication. In this situation, the analytical functions for stresses described here may be used to monitor and analyze the stresses during the fabrication process, e.g., as a tool for controlling the fabrication process or for screening defective wafers or devices prior to completion of the entire fabrication process.

The above analytical expressions and computations of stresses for structures with embedded line features and vias have been demonstrated to have a high accuracy in comparison with results of computation-intensive numerical finite element method (FEM). For example, for aspect ratios t>3b for the line features, the accuracy of the explicit analytical expressions is within about 5%. Hence, for many practical designs, the analytical computations are sufficiently accurate and are particularly advantageous in providing a high-speed stress monitoring mechanism for in-situ systems and applications.

As another example of the applications, the above analytical estimates of stresses for horizontal line features and vertical vias may be used during the design phase or the fabrication phase to determine whether a critical temperature threshold or a critical curvature threshold has been reached beyond which failure of a line feature or via will occur or becomes statistically probable. Such a failure threshold criterion may be based on known critical levels for individual stress components (or their combinations) leading to material failure such as fracture of a structure (e.g., a brittle dielectric feature), dislocation formation and coalescence, delamination of a line feature from its encapsulating or passivating layer, or metal voiding. In optoelectronic components and devices, a failure criterion may be related to critical levels of hydrostatic stress and principle stress differences in lines leading to undesirable changes of refractive index and optical birefringence, respectively. For voiding in metal lines, a failure criterion may be related to spontaneous void nucleation (cavitation) under the action of hydrostatic stresses acting on the line as a result of thermal excursion. The critical level of hydrostatic stress sufficient to nucleate a void is typically greater than the uniaxial yield (flow) stress of the material in the line by a factor, α (e.g., 2-5 times). For a given failure threshold criterion for a given structure, the above analytical expressions may be used to determine combinations of parameters of features and temperatures for the critical stresses so that the given critical failure condition may be avoided by proper designs of the structures and the fabrication processes.

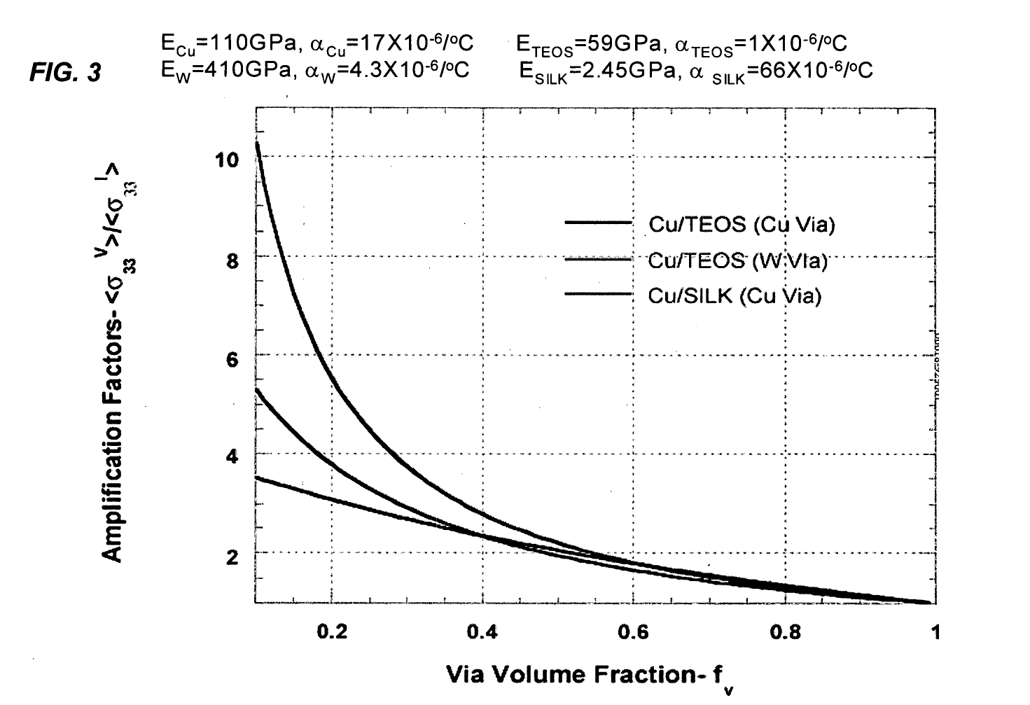

FIG. 4 illustrates cavitation in one of the line features in FIGS. 1A, 1B, and 2 when the stresses in that line feature meet an associated failure criterion. In general, the average value of the three stress components σ₃₃^{L}, σ₂₂_{L}, and σ₁₁^{L} is defined as a hydrostatic stress, σₕ^{L}, and is used to determine whether cavitation occurs.

In computing the critical stresses, the stresses may be expressed in terms of the change in temperature so that the critical change in temperature (ΔT_{c}) may be computed to determine whether a failure criterion is satisfied based on the given information on materials and geometry of the structure. The stress component on a line feature for a critical failure condition may be written as follows:
σᵢⱼ^{L}=σᵢⱼ^{L}(b/d,E_{L},E₀,ν_{L},ν₀,α_{L}−α_{S},α_{L}−α₀,ΔT),
Where parameters i and j are taken on any values of integers 1, 2, and 3. Alternatively, the stresses may be expressed in terms of the change in one of the curvatures so that the critical values for the curvature changes may be computed to determine whether a failure criterion is satisfied based on the given information on the structure. The stress component on a line feature for a critical failure condition may be written as follows:
σᵢⱼ^{L}=σᵢⱼ^{L}(b/d,E_{L},E₀,Eₛ,ν_{L},ν₀,α_{L}−α_{S}, α_{L}−α₀,h_{ƒ},hₛ,ΔK₁₁).
The material parameters of the capping layer and thickness of the line features should be included in the above expression when the capping layer is made of a material different from the material filled between the line features. Hence, a failure criterion, e.g., (σ₃₃^{L}+σ₂₂^{L}+σ₁₁^{L})/3=ασ_{y}, may be used in the above analytical expressions to obtain analytical expressions for the critical changes in temperature (ΔT_{c}) and curvature (ΔK₁₁^{c}) in terms of, e.g., the metal flow stress and the thermal and mechanical properties of a structure as follows:
ΔT_{c}=ΔT_{c}(σ_{y},b/d,E_{L},E₀, . . . )
ΔK₁₁^{c}=ΔK₁₁^{c}(σ_{y},b/d,E_{L},E₀, . . . )

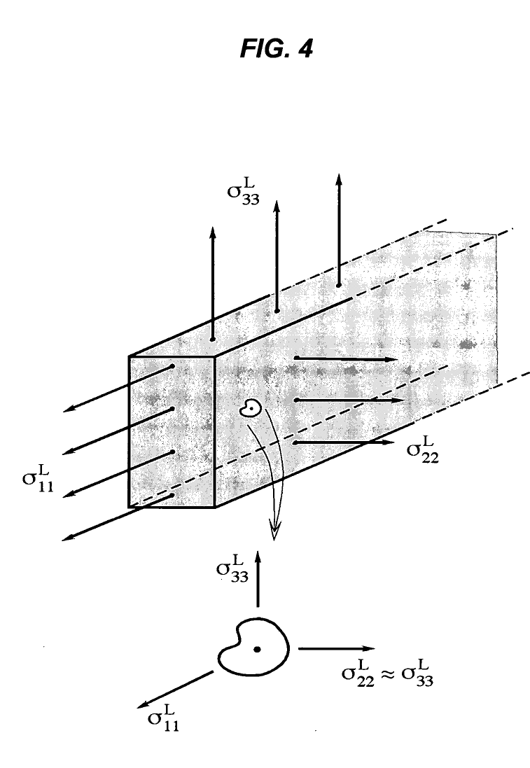

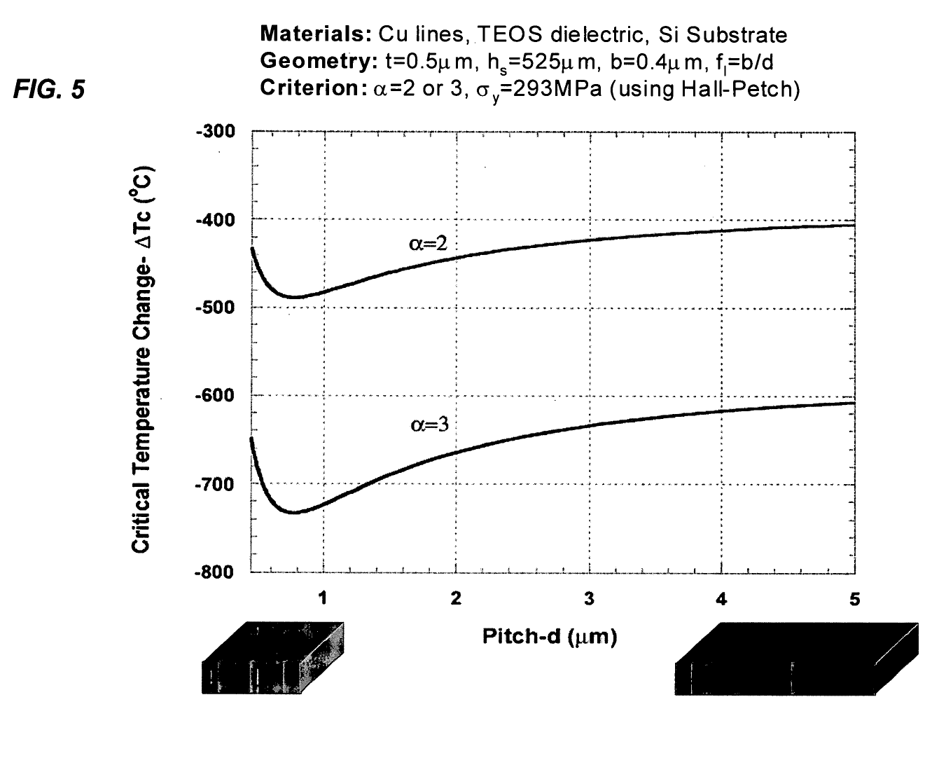

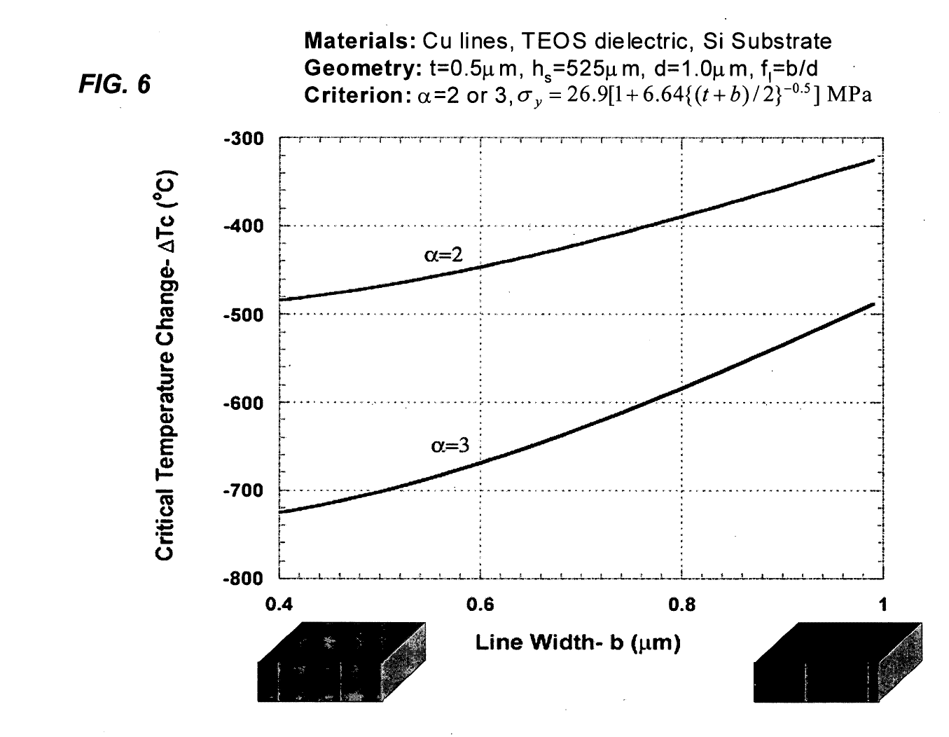

FIGS. 5 to 7 illustrate examples for establishing critical thresholds as a function of line geometry parameters for a single level structure of encapsulated or embedded periodic lines without a capping layer. The parameter α in FIGS. 5 to 7 is the ratio of the critical failure stress over the uniaxial yield stress of the material. In FIG. 5, the critical value of the change in temperature for Cu lines in TEOS dielectric over a Si substrate is plotted as a function of the line pitch d in microns. Hence, the operating temperature or the processing temperature for such structures should be set away from the critical values to avoid any potential failure. FIGS. 6 shows critical values of the change in temperature for Cu lines in a TEOS dielectric layer over a Si substrate as a function of the line width b. FIG. 7 shows critical values of the change in curvature for Cu lines in a TEOS dielectric layer over a Si substrate as a function of the line pitch d.

For vertical vias connecting multiple line levels, a similar methodology can be used to calculate critical thresholds for changes in temperature or curvature that may cause a via failure such as the via pullout or pushin. Critical values for changes in the temperature and curvature may be symbolically expressed as follows:
ΔT_{c}=ΔT_{c}(σ_{y},b/d,V,R,E_{L},E_{O},E_{V},ν_{L},ν_{O},α_{L}−αₛ,α₀−αₛ,α_{L}−α_{O},α_{V}−α_{O}),
and
ΔK_{hd 11}^{c}=ΔK₁₁^{c}(σ_{y},b/d,V,R, . . . ).
These expressions are functions of via and line geometries, the material properties for the materials used, and the via yield or flow strength.

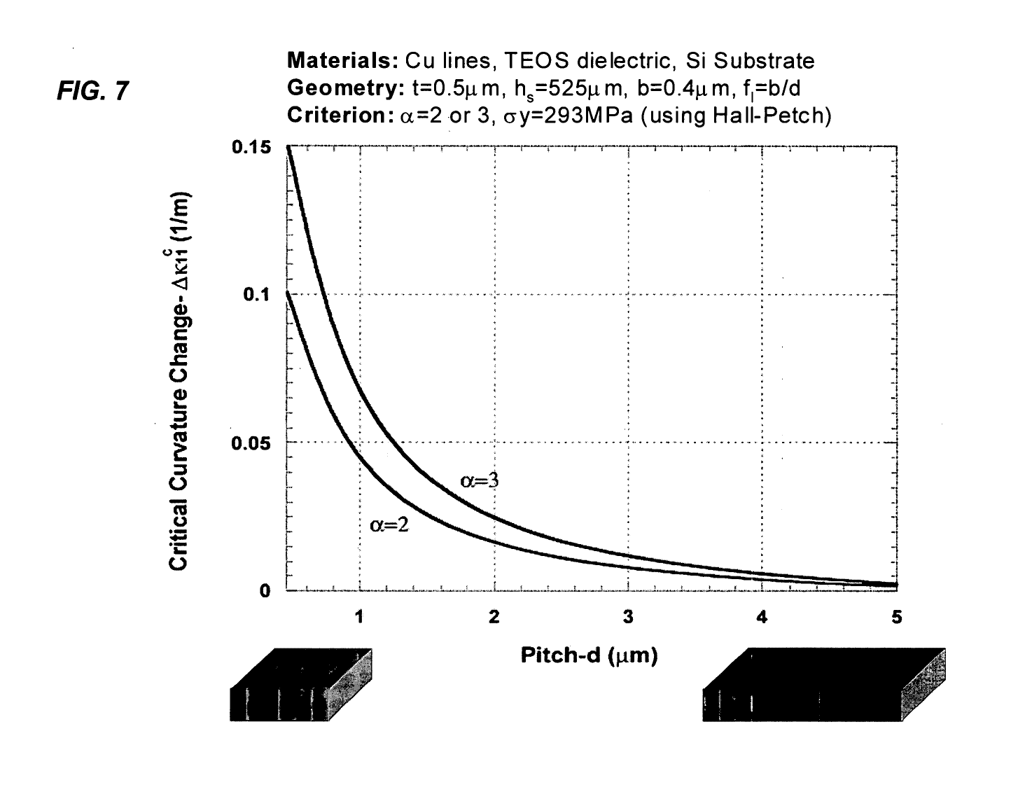

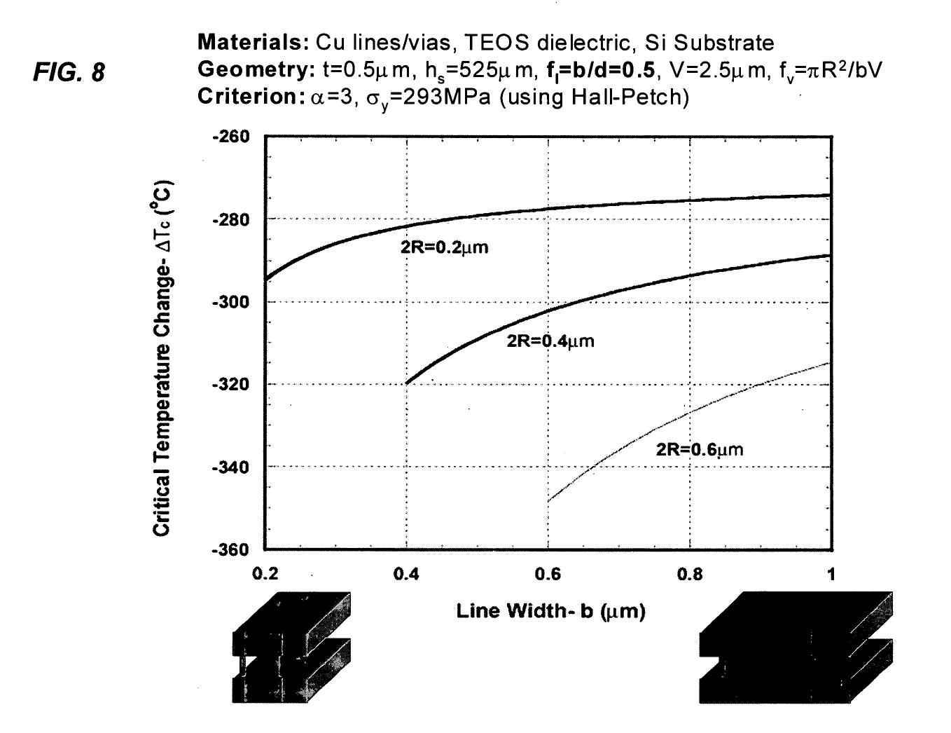

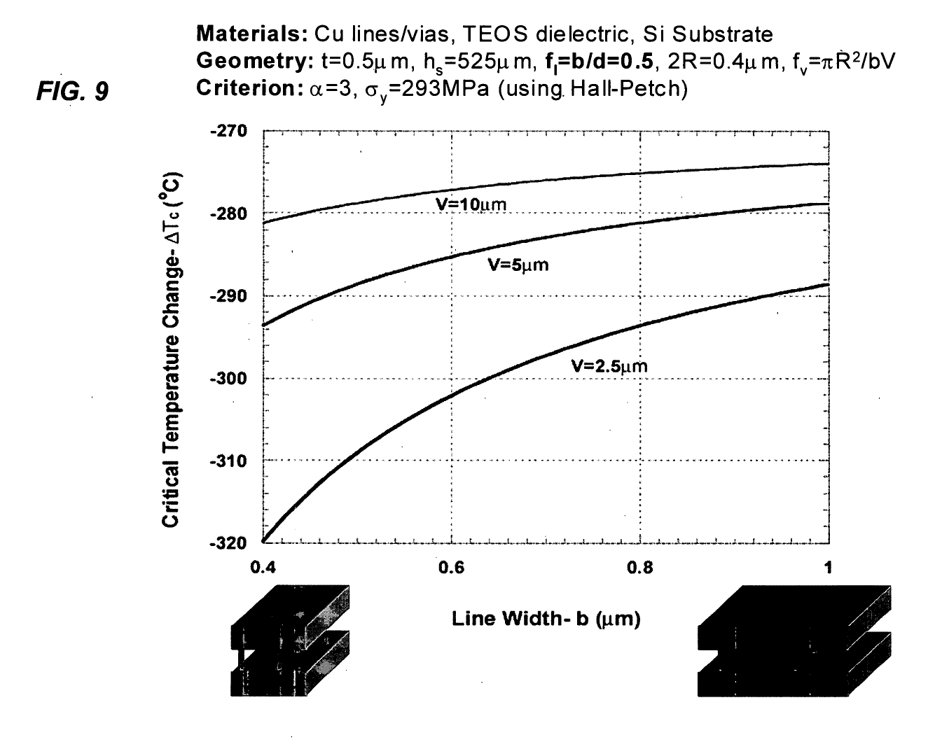

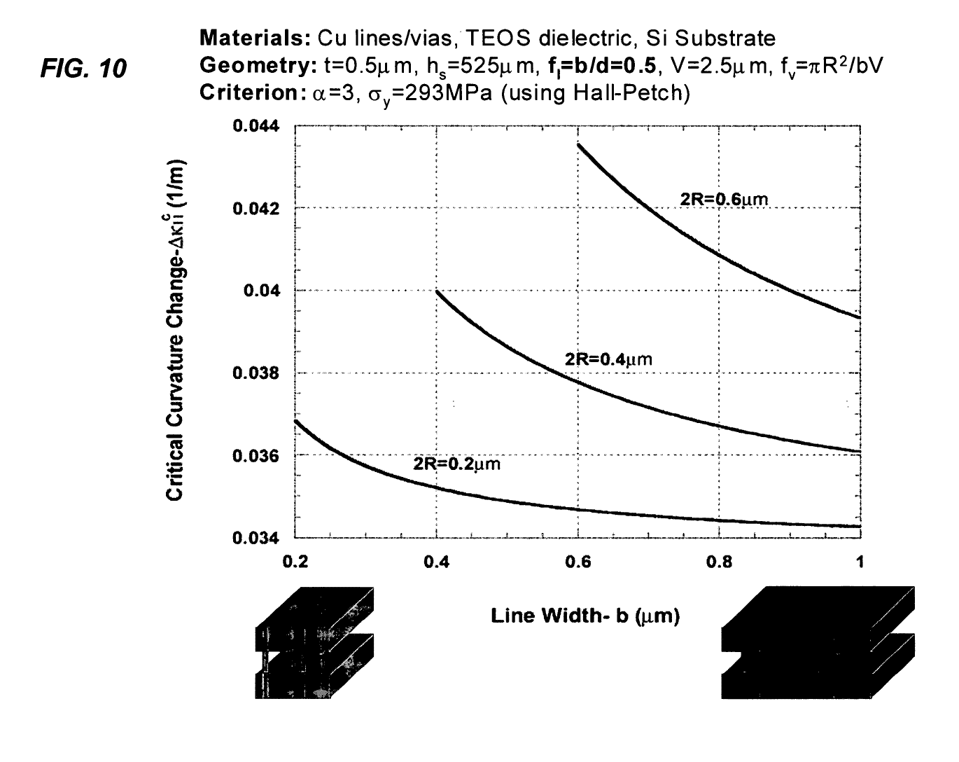

Examples for estimating critical threshold values for vias are shown in FIGS. 8, 9, 10 and 11 where the dependence of temperature and curvature threshold values on line and via geometry is obtained for configurations specified in the captions.

The above analytical expressions and computations may be implemented as design tools for various devices and as monitoring tools for various stress measurement or monitoring systems. Examples of such implementations are now described below.

In designing integrated structures with embedded line features or vias, the above analytical tools may be used to estimate whether a particular design structure, selection of materials, or fabrication conditions would cause any undesirable stress conditions in contemplated or proposed structures. In particular, in any one of the design structure, the selection of materials, and the fabrication conditions may be adjusted based on the analytical computations so that the stresses in the structures remain within a desired range to avoid any potential stress-induced defect or failure. This design process may be an iterative process where one or more design parameters may be modified multiple times through an optimization process after going through the analytical computations before a desired design is obtained. The analytical tools described above may be built into a design optimization software tool to facilitate the design.

In other applications, the above analytical tools may be implemented in various stress measurement or monitoring systems.

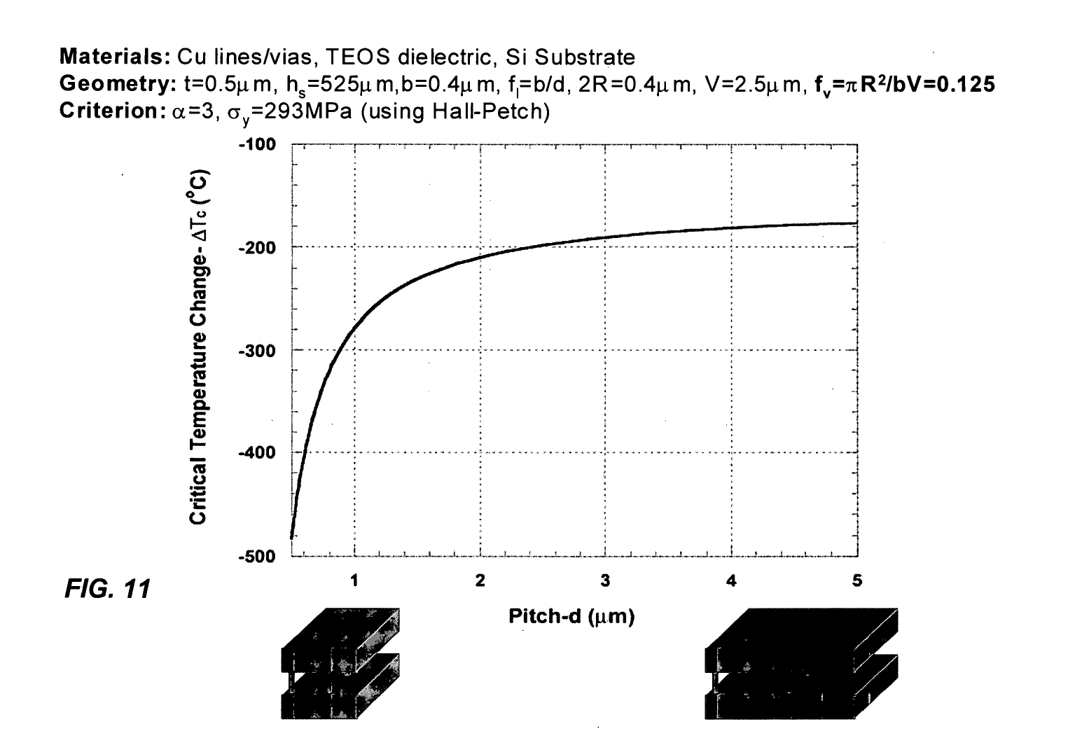

FIG. 12 shows one exemplary stress monitoring system 1200. A substrate holder 1201 is provided to hold a sample substrate or wafer with an embedded line structure. A sensing module 1202 is coupled to measure a property of the sample substrate, such as a temperature variation, curvature information of the surface under measurement, or both, to produce a measurement signal 1203. A processing module 1210 is programmed to process the information in the signal 1203 according to one or more analytical expressions described in this application and to produce the stress information 1212 in the layer structure of the sample substrate. The sensing module 1202 may be equipped to measure the temperature variations of the sample substrate, the surface curvatures of the sample substrate, or both to produce the measurement signal. The processing module 1210 may include a computer to store instructions for computing the stresses based on the analytical expressions.

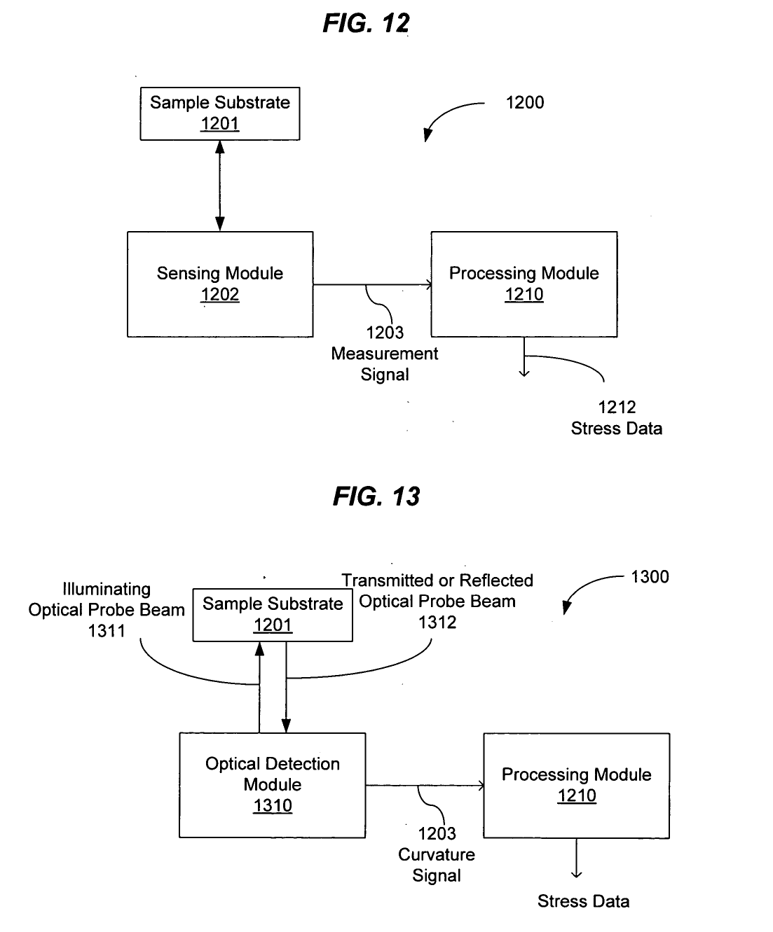

FIG. 13 shows a stress measurement system 1300 using an optical detection module 1310 to implement the optical detection mechanism and the processing module 1210 to implement the processing mechanism. A separate temperature sensing module may also be implemented to obtain temperature measurements at selected locations on the sample wafer to monitor the variation in temperature. The optical detection module 1310 produces an illumination optical probe beam 1311 to a surface of the sample substrate and then detects the transmitted or reflected beam 1312. The illumination beam 1311 is directed so as to illuminate an area which includes one or more areas under measurement either in a full field optical measurement configuration or a point-to-point scanning configuration. The transmitted or reflected beam 1312 from the sample substrate is then optically processed to produce an optical pattern that has the curvature information of the entire illuminated area. This optical pattern is converted into a curvature signal 1203. The signal 1203 is sent to the processing module 1210 which may include an electronic processor or other type of processor. The curvature signal 1203 may be an electronic signal representing the optical pattern. The signal is then processed to produce curvature data for the entire illuminated area on the substrate. The processing module 1210 produces desired stress data 1212 on line features formed on any one or more desired locations in the illuminated area on the substrate based on respective curvature data.

Optical systems for implementing the optical detection module 1310 for obtaining surface curvature information may use a full-field optical shearing interferometry configuration to optically obtain surface gradient information. In general, a shearing interferometer optically processes a distorted wavefront to cause wavefront interference. This interference is caused by optically shearing or shifting the wavefront and is used to measure the local slope of the wavefront and surface topology deviations. Such a shearing interferometer directs the distorted wavefront through a device or component of the system designed to optically shear or shift the wavefront enabling the measurement of the wavefront slope. A coherent gradient sensing (CGS) system, as one exemplary implementation of the optical shearing interferometry system, uses two optical gratings to produce the shifted wavefronts by diffraction and an imaging device to capture the desired diffraction orders. The interference pattern captured in the imaging device is then processed to obtain the slope information of the wavefront. In addition to CGS, other examples of shearing interferometers and shearing devices or components include a radial shear interferometers, wedge plate in a Bi-Lateral Shearing Interferometer (U.S. Pat. No. 5,710,631), and others. The system may use any radiation source including visible and invisible, coherent and incoherent light, IR and UV radiation.

The use of optical shearing interferometry present certain advantages in optically measuring surfaces including surfaces patterned with various microstructures such as patterned wafers and patterned mask substrates used (in-delete) to support, e.g., integrated circuits, integrated optical devices, integrated opto-electronic devices, and MEMs devices. In addition, an optical shearing interferometer may be used in the in-situ monitoring of the surface properties such as curvatures and related stresses during fabrication of devices at the wafer level and the measurements may be used to control in real time, the fabrication conditions or parameters. As an example, measurement and operation of an optical shearing interferometer generally is not significantly affected by rigid body translations and rotations due to the self-referencing nature of the optical shearing interferometry. Hence, a wafer or device under measurement may be measured by directing a probe beam substantially normal to the surface or at low incident angles without affecting the measurements. By shifting or shearing the wavefront, the optical shearing interferometer measures the deformation of one point of the wavefront to another separated by the shearing distance, i.e., the distance between the two interfering replicas of the same wavefront. In this sense, the optical shearing interferometer is self referencing and thus increases its insensitivity or immunity to vibrations of the wafer or device under measurement. This resistance to vibrations may be particularly advantageous when the measurement is performed in a production environment or in situ, during a particular process (e.g. deposition within a chamber), where vibration isolation is a substantial challenge.

A surface with device patterning poses several challenges for conventional (non-shearing) interferometers. A conventional interferometer generates wavefront interference of topology or topography based on interference between a wavefront reflected from a sample and a wavefront reflected from a known reference. Conventional interferometers used to measure surfaces with device patterning are frequently ineffective as the relatively non-uniform or diffuse wavefront reflected off the patterned surface does not interfere coherently with the wavefront reflected off the reference mirror, preventing the unwrapping and interpretation of the interferometric image.

In applying shearing interferometry for measuring patterned wafers, the patterned wafers, e.g., semiconductor and optoelectronic wafers with diameters of 200 mm, 300 mm, etc., may be placed in a shearing interferometer in a configuration that allows a collimated probe beam to be reflected off the wafer surface. Using a shearing interferometer on a patterned wafer results in coherent interference because the two interfering wavefronts are substantially similar in shape after being sheared by a small distance. Although each wavefront reflected off a patterned surface may be inherently noisy and diffuse, there is sufficient coherence between the wavefronts for meaningful fringe patterns to form and be interpreted when recombined in this fashion.

The method for using shearing interferometers to measure patterned wafers may be further improved with the use of phase shifting. Phase shifting may be implemented to progressively adjust the phase separation between interfering wavefronts which cycles or manipulates fringe position on the specimen's surface. In one implementation, a shearing interferometer may be configured to obtain multiple phased images of a patterned wafer's surface, for example at 0, 90, 180, 270 and 360 degrees in phase. The phase shifting method allows for wavefront slope to be measured by calculating the “relative phase” modulation at each pixel on a detector array. The method also allows for consistent interpretation of wavefront and specimen slope on a surface that exhibits changing reflectivity, like those found on patterned wafers. On a patterned wafer surface each pixel location on the specimen will reflect light with varying degrees of intensity, complicating the interpretation of any single sheared interferogram. Employing phase shifting simultaneously increases the accuracy of the slope resolution and allows accurate interpretation of interferograms on Patterned Surfaces with varying reflectivity by measuring the relative phase of each pixel rather than fringe separation or variation in the fringe intensity.

Having collected multiple phase shifted interferograms of the patterned wafer surface, a unwrapping algorithm may be subsequently used for the accurate interpretation of surface slopes. Suitable unwrapping algorithms include, but are not limited to, Minimum Discontinuity (MDF) and Preconditioned Conjugate Gradient (PCG).

Once the interferograms have been unwrapped the interpretation of raw slope data and the derivation of curvature is further enhanced by statistically fitting a surface polynomial to the raw slope data. Statistical surface fits, including Zernicke polynomials, may be applied to raw slope data derived from Patterned Wafers for the purpose of deriving topology and curvature data.

Shearing interferometry uses a single derivative, i.e., optically differentiates the wavefront once, to calculate curvatures from slopes of the wavefront. Secondly, because the method uses full-field interferometric data it typically uses many more data points than capacitive probe methodologies. In addition, various laser beam scanning tools may also be used to measure wafer bow or surface curvature. These methods typically measure radial curvature. Shearing interferometry may easily measure slope in two orthogonal directions allowing elucidation of the full curvature tensor and stress state of the wafer or the fabricated structures on the wafer.

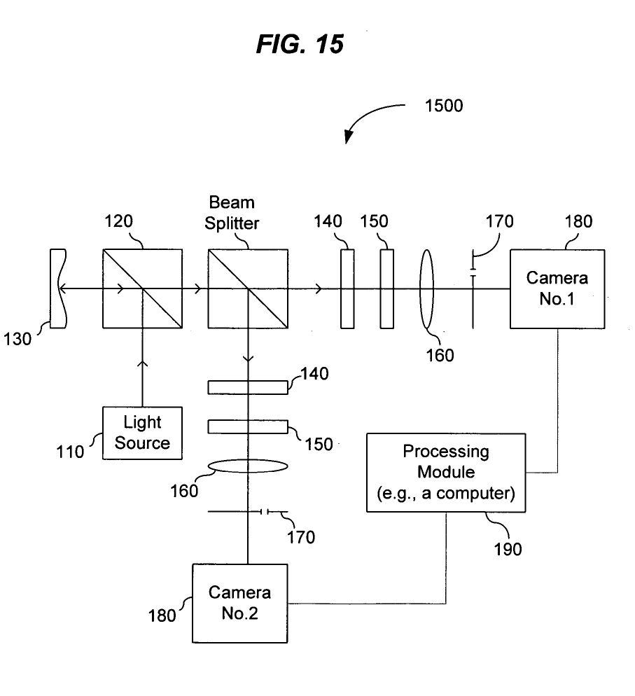

FIG. 14 shows an exemplary coherent gradient sensing (“CGS”) system 1400 as one implementation of an optical shearing system as the optical detection module 1310 in FIG. 13. See, U.S. Pat. No. 6,031,611 to Rosakis et al. The CGS system 1400 uses a collimated coherent optical beam 112 from a light source 110 as an optical probe to obtain curvature information indicative of a specularly reflective surface 130 formed of essentially any material. An optical element 120 such as a beam splitter can be used to direct the beam 112 to the surface 130. When the reflective surface 130 is curved, the wavefront of the reflected probe beam 132 is distorted and thereby the reflected probe beam 132 acquires an optical path difference or phase change associated with the curvature of the surface 130 under measurement. This system produces a “snapshot” of each point within the illuminated area on the surface 130 and hence the curvature information at any point along any direction within the illuminated area can be obtained. This can eliminate the need for measuring one point at a time in a sequential manner by using a scanning system.

Two gratings 140 and 150 spaced from each other are placed in the path of the reflected probe beam 132 to manipulate the distorted wavefront for curvature measurement. Two diffraction components produced by the second grating 150 diffracting two different diffraction components produced by the first grating 140 are combined, by using an optical element 160 such as a lens, to interfere with each other. The diffraction by the two gratings 140 and 150 effectuates a relative spatial displacement, i.e., a lateral shift, between the two selected diffraction components. This lateral shift is a function of the spacing between the two gratings 140 and 150 when other grating parameters are fixed. A spatial filter 170 is placed relative to the optical element 160 to transmit the interference pattern of the selected diffraction components through a pinhole 172 and to block other diffraction orders from the second grating 150.

The transmitted interference pattern is then captured by an imaging sensor 180 which may include an array of sensing pixels, such as a CCD array, to produce an electrical signal representing the interference pattern. A signal processor 190, which may be a part of the processing module 1210 in FIG. 13, processes the electrical signal to extract a spatial gradient of the wavefront distortion caused by the curvature of the reflective surface 130. This spatial gradient, in turn, can be further processed to obtain the curvature information and hence a curvature map of the illuminated area on the surface 130 can be obtained. A single spatial differentiation is performed on the interference pattern to measure the surface curvatures. This technique can provide accurate measurements of surface curvatures when the curvature variation of the surface is gradual, i.e., when the out-of-plane displacement is less than the thickness of the film, the line or the substrate. This technique is insensitive to rigid body motion in comparison with some other interferometric techniques. Details of this data processing operation are described in the above-referenced U.S. Pat. No. 6,031,611 to Rosakis et al. Upon completing the processing for the surface curvatures, the processor 190 further operates to compute the stresses from the surface curvatures based on the analytical expressions from the multi-layer models described here.

The two gratings 140 and 150 in general may be any gratings, with different grating periods and oriented with respect to each other at any angle. Preferably, the two gratings may be oriented with respect to each other in the same direction and may have the same grating periods to simplify the data processing. In this case, the grating direction is S essentially set by the direction of the relative spatial displacement (“shearing”) between the two selected diffraction components due to the double diffractions by the gratings 140 and 150.

In the CGS system shown in FIG. 14, the phase shifting may be achieved by adjusting the relative position of the two gratings 140 and 150 in the plane defined by x1 and x2 that is perpendicular to the x3 direction while the separation between the gratings along the x3 direction is fixed. A positioning mechanism, such as precise translation stage or a positioning transducer may be used to implement this adjustment of the relative position between the gratings for phase shifting.

Certain applications may require spatial shearing in two different directions to obtain a full-field two-dimensional curvature measurement. This may be done by using the CGS system 1400 to perform a first measurement when the sample surface 130 is at a first orientation and subsequently to perform a second measurement when the sample surface 130 is rotated to a second orientation (e.g., perpendicular to the first orientation).

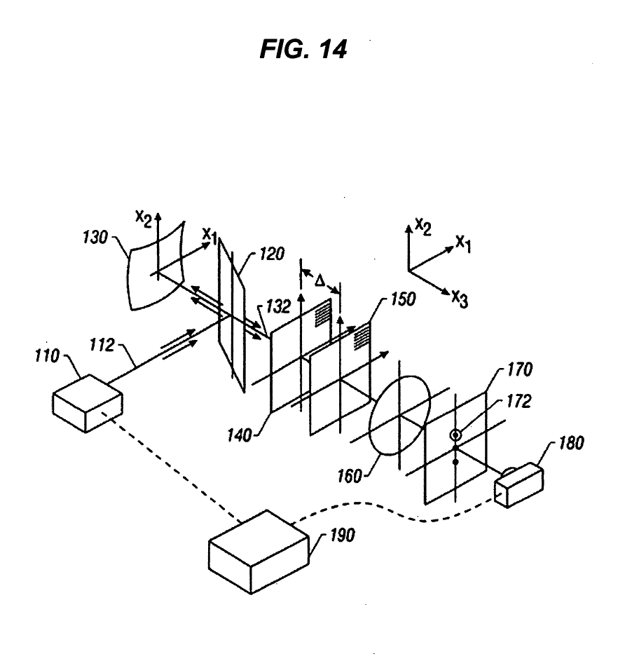

Alternatively, a two-arm CGS system, shown in FIG. 15 may be implemented to have two separate sets of double gratings in two different directions to simultaneously produce the interference pattern in two different spatial shearing directions. Hence, time-varying effects in the curvature distribution in both spatial shearing directions can be obtained. In addition, each of the two gratings 140 and 150 in FIG. 14 may be replaced by a grating plate with two orthogonal cross gratings to effectuate the two dimensional shearing of the system in FIG. 15 The spatial filter 170 may be replaced by a substitute filter with an additional optical aperture shifted along the direction of x1 to selectively transmit an interference pattern for shearing along the orthogonal direction.

The above CGS and other optical shearing interferometry systems may be used to measure curvatures of various features and components formed on a substrate either directly or indirectly. In the direct measurement, the probe beam in the CGS can be directly sent to the top, patterned surface of the processed wafers or substrates to obtain the curvature information. The surface features and components and their surrounding areas in this mode of operation may be smooth and optically reflective. In addition, it may be desirable in some cases that properties of the features and components and their surrounding areas other than their curvatures do not significantly contribute to the wavefront distortion. Hence, the wavefront distortion can be used as an indicator of the curvatures of the area illuminated by optical probe beam. For example, some completed integrated circuits have a top passivation layer, usually made of a non-conductive dielectric material, over the circuit elements on the substrate to protect the underlying circuits. The surface of the passivation layer is in general smooth and is sufficiently reflective for CGS measurements.

However, the above desirable conditions may not be met in some other substrate-based devices. For example, features and components formed on the front side of a substrate or their surrounding areas may not be optically reflective. The features and components on the front side may distort the reflected wavefront due to factors other than the curvatures, such as the height of a feature or component being different from its surrounding areas. In these and other situations, the curvatures of the features or components may be indirectly measured by inference from the curvature measurements of the corresponding locations on the opposite surface on the back side of the substrate. This is possible because the stresses in the non-continuous features and components formed on the substrate can cause the substrate to deform and the thin films formed over the substrate generally conform to the substrate surface.

When the heights of certain features are different from s their surroundings, the phase distortion on the wavefront of the reflected probe beam for each feature includes at least the portion contributed from the height difference and the portion contributed from the curvatures. In addition to using the back side of the substrate for the CGS measurement, the CGS measurement may also be performed by illuminating the front side. The curvature information can thus be extracted by removing the effects of the height difference in computation of the curvatures if the height information is known.

The stress computation for a multi-layer structure uses simple analytical formulae and hence the stress computation based on the measured changes in curvatures k1 and k2 can be carried out by a processor in a short time. For example, a microprocessor can be used to implement a computer routine to carry out the computations. Hence, complex and time-consuming numerical computations are essentially avoided. This feature of the data processing module, when combined with the full-field parallel processing of the optical shearing interferometry detection module (e.g., CGS), allows the stress measurement at a relatively high speed. Therefore, such systems may be used to measure temporal changes of curvatures and associated stresses in line features and vias of multi-layer structures in real time for various fabrication processes.

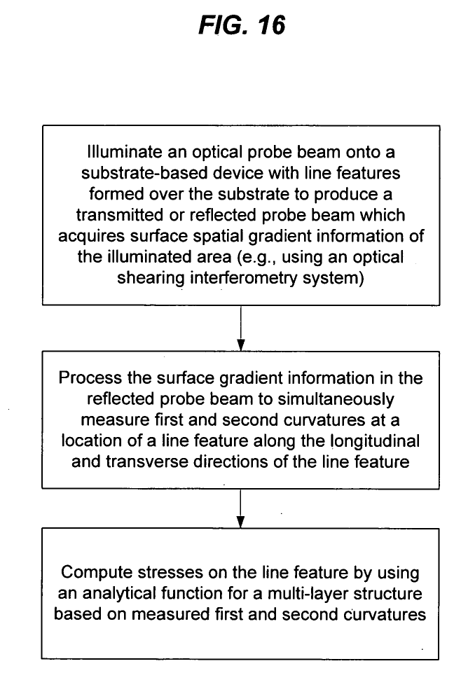

FIG. 16 illustrates an exemplary process for applying the above method using the optical method to compute the stresses in a multi-layered structure deposited on a wafer.

In in-situ real-time monitoring systems, the stresses in a wafer with a multi-layer structure under fabrication determined by the system may be used as a feedback signal to affect the subsequent fabrication process. For example, if the measured stresses exceed acceptable values, the devices on the wafer may be considered defective and hence the fabrication may be terminated. Alternatively, acceptable stress values may be designed as an indicators of the thermal cycling conditions and the thermal cycling conditions may be adjusted in real time according to the measured stresses to ensure the quality of the devices on the wafer.

The above analytical tools for determining stresses in multi-layer structures may be used as design tools in designing the devices and the fabrication processes. For example, various candidates materials for metallic line features, the interlayer dielectric layers (e.g., capping layers), and the vias may be evaluated with the analytical formulae so that the stresses during the fabrication and the final device using such materials are acceptable. The analytical formulae may also be used to identify a desired geometry for a multi-layer structure that can minimize stress buildup and optimize structure reliability (optimal design against stress induced failure). As yet another example, the temperature variations during each fabrication process, including a thermal cycling process such as the anneal process, may be evaluated so that the actual operating temperatures can be set to confine the stresses within an acceptable range during the fabrication.

The analytical expressions described above may also be used as a means for evaluating the fatigue life of a component subjected to repeated thermal excursions during operation. This may be achieved by implementing an appropriate fatigue life criterions, a stress migration or a stress induced electromigration failure criterion in the above analytical expressions. The critical temperature or curvature thresholds that lead to device or component failure can be computed from the analytical expressions to establish estimates of remaining service life.

Only a few implementations are described. However, it is understood that variations and enhancements may be made.

1. A method for designing a layered structure on a substrate, comprising:
providing a layered structure comprising at least one dielectric layer over a substrate and parallel line features embedded in the dielectric layer;
using analytical expressions to compute stresses in a line feature from curvature information of the substrate in an area of the line feature, local temperature information, geometry information of the line feature, the dielectric layer, and the substrate and material information of the line feature, the dielectric layer and the substrate;
using computed stresses to determine whether a stress-induced failure condition is met;
adjusting a parameter of the layered structure if the stress-induced failure condition is met;
using the analytical expressions to compute stresses in the line feature based on the adjusted parameter; and
continuing to adjust the parameter until the stress-induced failure condition is not met.

2. The method as in claim 1, wherein the parameter is a geometry parameter.

3. The method as in claim 1, wherein the parameter is a material property of one of the line feature, the dielectric layer, and the substrate.

4. The method as in claim 1, wherein the parameter is a temperature under which a device made from the layered structure operates in normal operations.

5. The method as in claim 1, wherein the parameter is a thermal budget under which the layered structure is processed during fabrication.

6. The method as in claim 1, wherein the layered structure comprises at least two dielectric layers with embedded line features and at least a vertical via that connects line features respectively in the two dielectric layers, the method further comprising:
using an analytical expression to compute a stress along the vertical via from a vertical stress of the connected line features, local temperature information, geometry information of the line features and the via, and material information of the dielectric layer and the via;
using computed stresses to determine whether a stress-induced failure condition for the via is met;
adjusting a parameter of the layered structure if the stress-induced failure condition for the via is met;
using the analytical expressions to compute stresses in the line features based on the adjusted parameter; and
continuing to adjust the parameter until the stress-induced failure condition for the via is not met.

7. A method for fabricating a layered structure on a substrate, comprising:
processing a substrate to form at least one dielectric layer on the substrate and parallel line features embedded in the dielectric layer;
obtaining local curvature information in an area of a line feature;
obtaining local temperature information in the area of the line feature; and
using analytical expressions to compute local stresses in the line feature from the local curvature information and the local temperature information of the line feature, geometry information of the line feature, the dielectric layer, and the substrate, and material information of the line feature, the dielectric layer and the substrate.

8. The method as in claim 7, further comprising using an optical probe beam to illuminate the layered structure and detecting optical reflection of the optical probe beam from the layered structure to obtain the local curvature information.

9. The method as in claim 8, further comprising directing the optical probe beam onto a surface of the substrate on which the dielectric layer and the parallel line features are fabricated.

10. The method as in claim 8, further comprising directing the optical probe beam onto a surface of the substrate that is opposite to a substrate surface on which the dielectric layer and the parallel line features are fabricated.

11. The method as in claim 8, further comprising using the optical reflection to further obtain curvature information of an area illuminated by the optical probe beam.

12. The method as in claim 8, further comprising using an optical shearing interferometer to optically process the optical reflection in obtaining the local curvature information.

13. The method as in claim 12, further comprising using two optical gratings in the optical shearing interferometer to perform optical shearing in optically processing of the optical reflection.

14. The method as in claim 12, wherein the optical shearing interferometer comprises a radial shearing interferometer.

15. The method as in claim 12, wherein the optical shearing interferometer comprises a bi-lateral shearing interferometer having a wedge plate.

16. The method as in claim 7, further comprising:
computing a critical value for a change in temperature according to a failure criterion of the layered structure by using the analytical expressions; and
controlling a variation in temperature during fabrication to be away from the critical value.

17. The method as in claim 7, further comprising:
computing a critical value for a change in curvature according to a failure criterion of the layered structure by using the analytical expressions; and
controlling a condition during fabrication to make a change in curvature to be away from the critical value.

18. The method as in claim 7, wherein the substrate comprises at least another dielectric layers with embedded line features on the dielectric layer and at least a vertical via that connects line features respectively in the two dielectric layers, the method further comprising:
using an analytical expression to compute a stress along the vertical via from a vertical stress of the connected line features, local temperature information, geometry information of the line features and the via, and material information of the dielectric layer and the via; and
adjusting a processing condition according to the computed stress along the vertical via.

19. The method as in claim 7, further comprising adjusting a processing condition according to the computed local stresses.

20. A system, comprising:
a substrate holder to hold a substrate fabricated with a dielectric layer and parallel line features embedded in the dielectric layer;
a sensing module to interact with the substrate to obtain information about a temperature and curvatures of a line feature on the substrate; and
a processing module programmed with analytical expressions to compute local stresses in the line feature from curvature and temperature information of an area having the line feature, geometry information of the line feature, the dielectric layer, and the substrate, and material information of the line feature, the dielectric layer and the substrate.

21. The system as in claim 20, wherein the sensing module comprises an optical shearing interferometer system that projects a probe light beam to the substrate to measure curvatures of the line feature.

22. The system as in claim 21, wherein the optical shearing interferometer system comprises a CGS system.

23. The system as in claim 21, wherein the optical shearing interferometer system comprises a radial shear interferometer.

24. The system as in claim 21, wherein the optical shearing interferometer system comprises a bi-lateral sharing interferometer that comprises a wedge plate which performs optical shearing.

25. The system as in claim 20, wherein the layered structure comprises at least two dielectric layers with embedded line features and at least a vertical via that connects line features respectively in the two dielectric layers, and
wherein the processing module is further programmed to use an analytical expression to compute a stress along the vertical via from a vertical stress of the connected line features, local temperature information, geometry information of the line features and the via, and material information of the dielectric layer and the via.

26. The system as in claim 25, wherein the layered structure comprises a capping layer on top of embedded line features and an adjacent top layer, wherein the processing module is programmed to include effects of the capping layer in the analytical expression.

27. A method, comprising:
providing a layered structure comprises a plurality of layers stacked over one another and each having embedded line features;
optically obtaining information on a surface of the layered structure;
processing the optically obtained information to extract curvature information of the surface; and
applying analytical expressions to compute local stresses in a line feature based on extracted curvature information and a local temperature at a location of the line feature.

28. The method as in claim 27, wherein the layered structure comprises at least one vertical via that connects line features respectively in two different dielectric layers, the method further comprising:
using an analytical expression to compute a stress along the vertical via from a vertical stress of the connected line features, local temperature information, geometry information of the line features and the via, and material information of the connected layers and the via.

29. The method as in claim 27, wherein the information on the surface is optically obtained by:
illuminating a probe beam to the surface to generate a signal beam carrying the information on the surface;
using an optical shearing interferometer to optically process the signal beam to produce a shearing interference pattern; and
using the shearing interference pattern to extract the curvature information.

30. The method as in claim 27, further comprising using a gradient sensing system having two optical gratings as the optical shearing interferometer to produce the shearing interference pattern.

31. The method as in claim 27, wherein the layered structure comprises at least one vertical via that connects line features in two different layers, the method further comprising:
using an analytical expression to compute a stress along the vertical via from a vertical stress of the connected line features, local temperature information, geometry information of the line features and the via, and material information of materials of the layers and the via.
